(19) United States
(12) Patent Application Publication
(10) Pub. No.: US 2019/0310663 A1
(43) Pub. Date: Oct. 10, 2019

(54) AUTOMATED SYSTEM AND DEVICE FOR MANAGING A PLURALITY OF OPERATIONS ASSOCIATED WITH A FACILITY

(71) Applicants: Paul Woodford, Sydney (AU); Barry Deacon, Kellyville (AU)

(72) Inventors: Paul Woodford, Sydney (AU); Barry Deacon, Kellyville (AU)

(21) Appl. No.: 16/016,569

(22) Filed: Jun. 23, 2018

(30) Foreign Application Priority Data
Apr. 10, 2018 (AU) 2018202533

(51) Int. Cl. G05D 7/06; G05B 19/416; G06F 21/62

(52) U.S. Cl. CPC G05D 7/0641; G05B 19/416; G05B 2219/37371; G05D 7/0682; G06F 21/62

(57) ABSTRACT

The present invention relates to an automated system for managing a facility having equipment operable using compressed air, water and steam supply, which includes an electronic control device having a control panel, a human machine interface and a programmable logic controller for controlling operations of the equipment based on real-time and preprogrammed inputs. The automated system further includes a steam supply control means in communication with the electronic control device to control steam supply, a compressed air supply control means in communication with the electronic control device to control a compressed air supply and a number of monitoring means to provide feedback information to the electronic control device. The electronic control device performs automated, scheduled operations by controlling electric and pneumatic values of the equipment based on analysis of inputs provided to the electronic control device and feedback received from the monitoring means.

### CROSS-REFERENCE TO RELATED APPLICATIONS

The present application relates and claims priority to Australian patent application No. 2018202533 filed on Apr. 10, 2018.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present invention relates to the field of automated control systems for managing a variety of operations in a facility. More particularly, the present invention relates to an automated system and a device for managing and automating the operations associated with a facility utilizing compressed air, water and steam supply.

### Description of the Related Art

Automatic and semi-automatic control systems and associated devices capable of automated and scheduled control of equipment in facility are known in the art. Such systems operate either on open or closed control loops, which controls the operation of a particular equipment in a facility. Some of these control systems are employed in many industrial facilities to control the start, stop, load and unload operation of various equipment in the facility. There are certain industries, which still largely operates on manual controls and with limited automation. Examples of such industries include dry cleaning, laundry, garment and textiles industries. These and related industries rely heavily on their equipment which requires the use of steam and compressed air to operate. The boilers and compressors require daily interaction from operators as well as regular maintenance to ensure reliability. The lack of regular maintenance causes a shortened life to equipment like boilers and air compressors. Both of these items require the vessels to be regularly blown down, which removes water from the compressor air storage vessel and removes dissolved solids from a boiler vessel. When this process is not done, the life of the equipment and the efficiency of operation is reduced. Many items used in these industries require the use of steam. In a normal operation, the boiler is activated in the morning and all the equipment has the supply steam available to it even if the item is only used in the afternoon. This situation causes the boiler to cycle more often than required which leads to greater energy use in the plant. However, there exists no systems and methods to completely manage, automate, schedule most of the operations such as starting, stopping, cleaning and scheduling of equipment in these facilities employing steam, water and compressed air.

There are several prior arts, which disclose systems and devices for controlling the steam supply, water supply or compressed air supply in industrial facilities. One such prior art is disclosed in U.S. Pat. No. 4,173,124 A titled “Boiler feed water pump control system”. The invention relates to a boiler feed water system, which is provided with a motor driven feed water pump and a steam turbine driven feed water pump. The control system comprises a digital computer including a flow quantity control system responsive to the degree of opening of a flow control valve and the discharge quantity of the motor driven feed water pump for controlling the flow quantity thereof, and a speed control system responsive to the speed and discharge flow quantity of the steam turbine driven feed water pump, head pressure of the feed water system and the operation of a control motor for a steam control valve of a pump driving turbine. The control is switched between the flow quantity control system and the speed control system in accordance the load of the plant. However the system cannot be employed for the complete control and management of a facility such as textile, cleaning, washing or other industries.

Another prior art U.S. Pat. No. 7,010,363 B2 titled “Electrical appliance energy consumption control methods and electrical energy consumption systems” discloses electrical appliance energy consumption control methods and electrical energy consumption systems. In one aspect, the invention relates to an electrical appliance energy consumption control method that includes providing an electrical appliance coupled with a power distribution system, receiving electrical energy within the appliance from the power distribution system, consuming the received electrical energy using a plurality of loads of the appliance, monitoring electrical energy of the power distribution system, and adjusting an amount of consumption of the received electrical energy via one of the loads of the appliance from an initial level of consumption to another level of consumption different than the initial level of consumption responsive to the monitoring.

However, most of these existing systems and methods cannot be utilized for the overall control and efficient management of the different equipment operating on water steam and compressed air in an industrial facility such as dry cleaning, laundry, garment and textiles industries. Hence there exist a need for a system and a control device that would allow users to schedule and automate the processes inside such industries with greater efficiency.

### BRIEF SUMMARY OF THE INVENTION

The present invention relates to an automated system for managing a variety of operations associated with a facility having a number of equipment operable using compressed air, water and steam supply. The present automated system includes an electronic control device having an air regulator and a number of air valves configured to automatically controlled to control and manage a number of automated, preset and real-time operations of the equipment involving steam, water and compressed air supply in the facility. The electronic control device includes a control panel, a human machine interface for providing a variety of real-time and preprogrammed inputs and a programmable logic controller for controlling operations of the equipment based on the real-time and preprogrammed inputs received through the human machine interface. The present automated system further includes a steam supply control means, which can either be a pneumatic valve operated using the air regulator of the electronic control device or a needle valve in the electronic control device to directly control steam supply lines. A compressed air supply means supply compressed air to the air regulator associated with the electronic control device, which in turn supplies the compressed air, water and steam to a number of equipment in the facility. A number of monitoring means is installed at different locations associated with the steam supply means to provide feedback information to the electronic control device. The compressed air supply means provides compressed air to the electronic control device through the air regulator mounted on the electronic control device. The air regulator associated with the electronic control device controls the compressed air supply to the different equipment installed at the facility based on pre-programmed or real-time instructions given to the electronic control device. The electronic control device performs a variety of automated, scheduled operations including start up, scheduled operation, automated cleaning and scheduled stopping of the equipment by controlling a number of electric and pneumatic values of the equipment based on analysis of a number of inputs provided to the electronic control device and a number of feedback information received from the monitoring means.

The automated system and electronic control device can be used as a system for preventative maintenance and for improving the energy efficiency by automatically starting, stopping and processing of electric steam and water based machinery. More particularly, the invention relates to the controlling of electric, pneumatic values for each part of the operation that use steam, water and air. The electronic control device is configured to connect with any existing electrical systems, which control the individual existing equipment, such as inlet/outlet valves, circuit breakers, pump timers, contactors and level switches for the machinery or the equipment within the industries or facilities using steam, water and air, which includes dry cleaning, laundry and garment and textile industry. By automating the daily start-up in the above industry for boilers, washers, dryers, dry cleaning machines, air compressors and finishing equipment, the electronic control device with its inbuilt options, can schedule different starting times, manually override each piece of equipment, start and stop different equipment, clean up of equipment using blowing down and draining of equipment, etc. The present system employing the electronic control device allows the workflow and processing time of a facility to become efficient and easy to control and configure with varying demands.

### DESCRIPTION OF THE DRAWINGS

To further clarify various aspects of some example embodiments of the present invention, a more particular description of the invention will be rendered by reference to specific embodiments thereof that are illustrated in the appended drawing. It is appreciated that the drawing depicts only illustrated embodiments of the invention and are therefore not to be considered limiting of its scope. Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness. The invention will be described and explained with additional specificity and detail through the use of the accompanying drawing in which:

FIG. 1 illustrates a block diagram of an automated system for managing the operations associated with one or more facilities employing equipment configured to operate on compressed air, water and steam, according to a preferred embodiment of the present invention.

FIG. 2 illustrates a schematic diagram showing an electronic control device of the present automated system employed to control and automate different operations of the equipment inside the facilities operating on steam, water and compressed air, according to an embodiment of the present invention.

FIG. 3 illustrates a line diagram showing the control and flow lines of the electronic control device of the present automated system employed to control the equipment inside the facility operating on steam, water and compressed air, according to an embodiment of the present invention.

FIG. 4 illustrates a line diagram showing the use of the electronic control device to schedule and control a boiler operation in the facility operating on steam, water and compressed air, according to an embodiment of the present invention.

FIG. 5 illustrates a schematic diagram showing the supply of compressed air to the electronic control device and the removal of water build up in the air compressor, according to an embodiment of the present invention.

### DETAILED DESCRIPTION OF THE INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention. The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

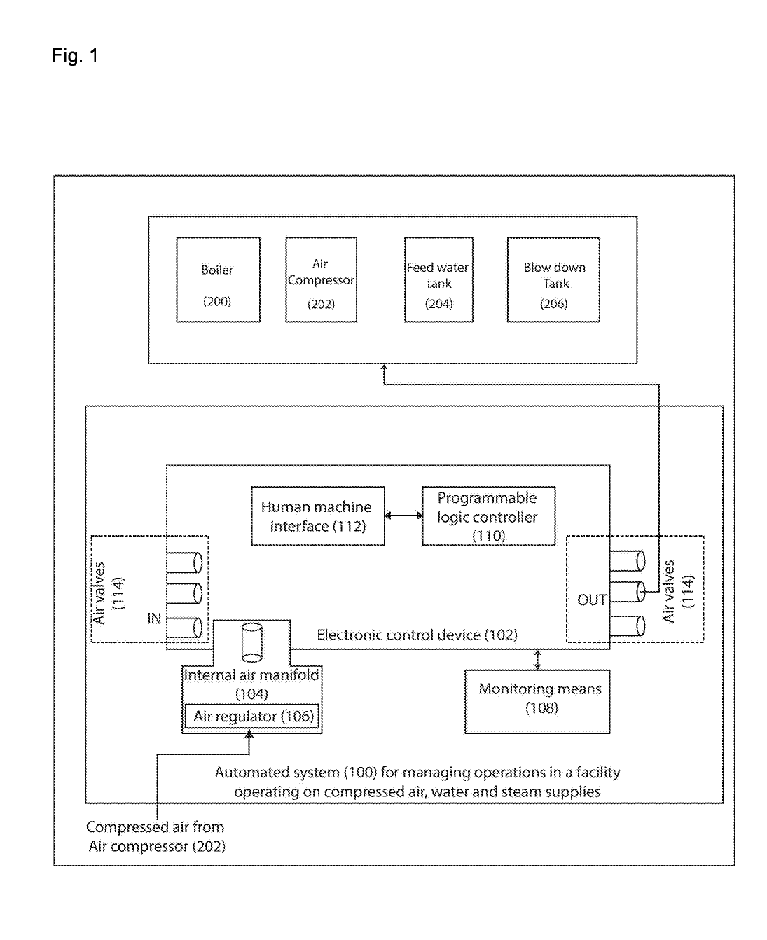

The present invention relates to an automated system and a device for managing a variety of operations associated with one or more facilities employing a number of equipment configured to operate on one or more sources of compressed air, water and steam supplies, according to a preferred embodiment and one or more additional embodiments of the present invention. The present invention employs one or more compressed air, water and steam supply means or supply systems to generate compressed air, water and steam of desired pressure and temperature for use in different processes performed using the equipments provided within the facility. FIG. 1 illustrates a block diagram of the present automated system 100 for managing the operations associated with the facilities employing one or more equipment configured to operate on compressed air, water and steam supplies at desired temperature and pressure levels, according to a preferred embodiment of the present invention. The present automated system 100 can be utilized for the automated, scheduled and manual operations and management of the equipment associated with the facilities such as, but not limited to, dry cleaning, laundry, and other garment and textile industries employing steam, water and compressed air to operate. In some instances, the present automated system 100 includes an electrical powered or gas powered boiler vessel 200 to generate steam for use in dry cleaning, laundry and other garment cleaning and finishing related machines employed in cleaning and textile industry in general. The present automated system 100 can be employed in similar facilities such as dry cleaning, laundry, garment and in textile industries to automate the processes including the generation, maintenance and scheduling of steam and for managing other related operations of the boiler vessel 200.

The present automated system 100 for managing the operations associated with the facilities having one or more equipment operable using compressed air, water and steam supply includes an electronic control device 102 configured to manage a number of automated, preset or scheduled and real-time operations of the equipment in the facility. The electronic control device 102 further includes a programmable logic controller 110 and a human machine interface device 112. The programmable logic controller 110 enables automated and scheduled control of the variety of operations of the equipment present in the facility. The programmable logic controller 110 monitors and controls the operation of the equipment based on preprogrammed inputs provided through the human machine interface device 112, which is in communication with the programmable logic controller 110 through a communication bus. The human machine interface device 112, according to an embodiment, includes a keyboard and/or a touchscreen display having a number of interactive controls for allowing the authorized personnel to configure the operations of the equipment associated with the facility using predefined program codes or instructions. The human machine interface device 112 enables the authorized personnel to provide inputs to control the real-time or scheduled operations of the equipment associated with the facility, using preset instructions or commands, provided through the interactive controls, such as, a graphical user interface of the touchscreen, on the human machine interface device 112.

The electronic control device 102 of the present automated system 100 is configured to install at any facility employing compressed air, water and steam supply equipment and can be used to partially or completely automate and schedule the processes including daily startups, stops, cleaning, and other operations of the equipment present in the facility. The electronic control device 102 associated with the present automated system 100 employed in industrial facilities such as, but not limited to, dry cleaning, laundry, garment and textile industries includes an internal air manifold 104 having a valve island with an air regulator 106. An air compressor 202 supplies compressed air to the internal air manifold 104 through the air regulator 106 associated with the present electronic control device 102. The present automated system 100 further includes a monitoring means 108 associated with the boiler vessel 200 to provide continuous or scheduled feedbacks to the electronic control device 102. The air regulator 106 on the electronic control device 102 associated with the present automated system 100 is in fluid communication with multiple pneumatic valves provided along the steam, water and air supply lines connected to the multiple equipment in the facility. This enables the present electronic control device 102 to control the steam, water and air supply to the different equipment in the facility through the use of the air regulator 106. In some instances, the programmable logic controller 110 enables automated and scheduled control of the variety of operations of the equipment present in the facility by dynamically controlling the air pressure through the air regular 106. In some other instances, the air regulator 106 supplies controlled air from the air compressor 202 to the multiple air valves 114 within the electronic control device 102, which in turn controls a number of pneumatic valves associated with the steam, water and compressed air supply to provide a controlled steam, water and compressed air supply to the different cleaning and finishing equipment in the facility such as, but not limited to, dry cleaning, laundry, garment and textile industries. In some instances, the multiple air valves 114 within the electronic control device 102 is configured to directly control the number of output valves or supply lines of the equipment such as compressed air supply equipment i.e. the air compressors 202, steam generation equipment such as boiler vessels 200, cleaning equipment associated the boilers 200 such as the blowdown tanks 206 and boiler parts for blowing down boiler vessels, water supply equipment such as feed water tanks 204 etc. In some other instance, the electronic control device 102 further includes an internal needle valve to directly control the speed of the main steam supply valve from the boiler 202, thereby efficient controlling of the other equipment in the facility such as the cleaning, washing and finishing equipment to optimize its operation. The air regular 106 and the associated air valves 114 are dynamically and automatically controlled based on the stored instructions from the programmable logic controller 110 or based on the real-time instructions received through the human machine interface device 112 of the electronic control device 102.

In some instances, the operation of the air regular 106 and the associated air valves 114 are dynamically and automatically controlled using the instructions set on the programmable logic controller 110 based on the scheduled or routine startups, stops, cleaning, and other operations of the respective equipment present in the facility. The cleaning operation of the equipment such as the boiler vessels 200, sight glasses 208, air compressors 202, feed water tanks 204, etc. includes blowing down the boiler vessels 200, purging of the sight glasses 208 on the boiler vessels using the pneumatic valve connected to the bottom of the sight glass 208, blowing down the air compressors 202, feed water tanks 204, etc. using high pressure water or using high pressure air to the blowdown tank 206 at scheduled intervals. The automated control of the air regular 106 and the associated air valves 114 enables scheduled, automated and efficient operation of the different equipment in the facility such as, but not limited to, dry cleaning, laundry, garment and textile industries.

The programmable logic controller 110 further allows the authorized personnel to configure or program the operations of the different equipments in the facility to allow a number of scheduled processes to occur based on the requirements of each of the operations, for the efficient operation of the equipment and the efficient overall functioning of the facility. Some of the scheduling, automation and programming operations of the programmable logic controller 110 can be provided through the interactive controls on the human machine interface device 112 in communication with the programmable logic controller 110. In facilities such as, but not limited to, dry cleaning, laundry, garment and textile industries, the processes controlled using the programmable logic controller 110 via the human machine interface device 112 includes the autostart operation of the equipment such as boiler vessels 200, air compressors 202, auto blow down of the boiler 200 and its sight glass 208, the activation of steam circuits to the various sections of the facility, auto blow down of the air compressors 202 and auto start and stop operations of the washers, dryers and associated equipment in the facility. In some instances, the interactive controls on the human machine interface 112 includes a number touchscreen buttons accessible to the authorized users through a touchscreen. The authenticity of the users is verified using either biometric or through the use of unique password combinations.

Further, the present automated system 100 is provided with a manual override switch to enable manual control of the operation of the different equipment in the facility. In some instances, the manual override switch is a control button or a soft control on the human machine interface 112. According to one or more embodiments, the present automated system 100 can be used to automate or schedule the daily startup of the equipment such as the boiler vessels 200, cleaning equipment and also allows the users to schedule different startup and stop times for the boiler vessel 200 and other equipment in the facility. The present automated system 100 can further be utilized to automate or schedule the starting and stopping times of the process of cleaning or blow down operation of the boiler vessels 200, purging of the boiler sight glass 208, automate or schedule the blow down or cleaning operation of the air compressors 202 to remove the water build up and the associated equipment in the facility. In one instance, the electronic control device 102 is provided within an IP66 controlled casing structure allowing the authorized personnel to access the automation, scheduling and controlling features of the device 102 via the interactive controls on the human machine interface device 112. The human machine interface device 112 and the programmable logic controller 110 in communication with the human machine interface device 112 and the respective equipment in the facility enables the authorized personnel to provide inputs to control the real-time or scheduled operations of the equipment associated with the facility, using preset instructions or commands, provided through the interactive controls on the human machine interface device 112. In some other instances, the present automated system 100 allows the authorized personnel to manually override any scheduled operation of the equipment such as the boiler vessels 200 by manually activating the manual override switch. Thus the desired automated scheduled operations of the equipment such as the boiler vessels 200 can be achieved in the industries such as, but not limited to, dry cleaning, laundry, garment and in textile industries, etc. This in turn improves the operating efficiency, overall efficient management of the labor work hours, increased lifespan of the equipment and the overall profitability of the facility.

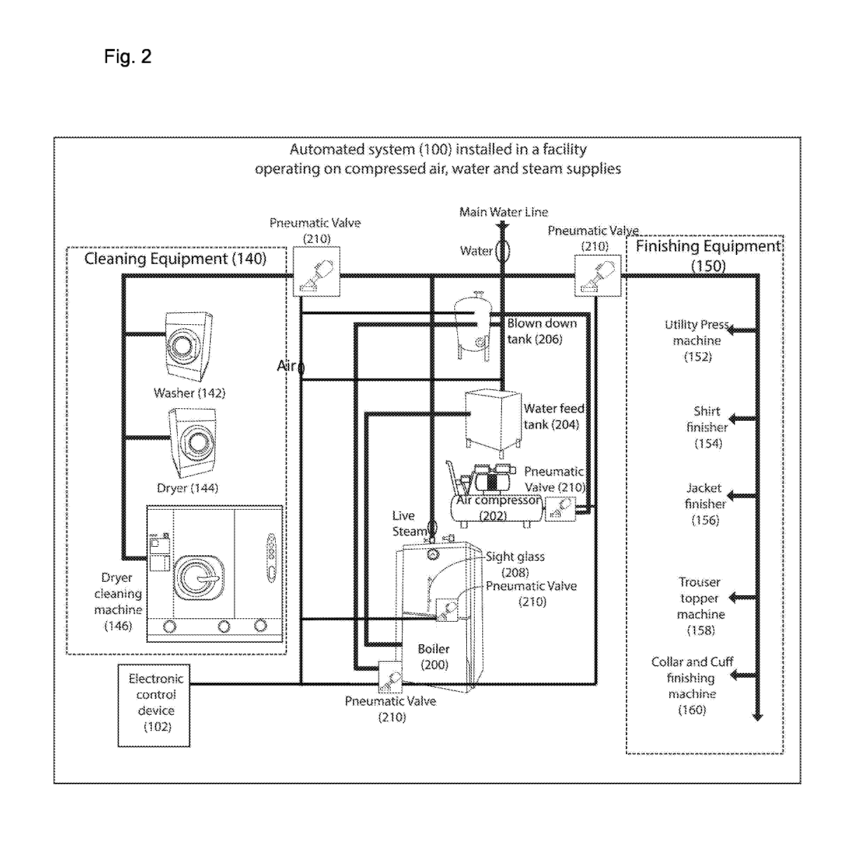

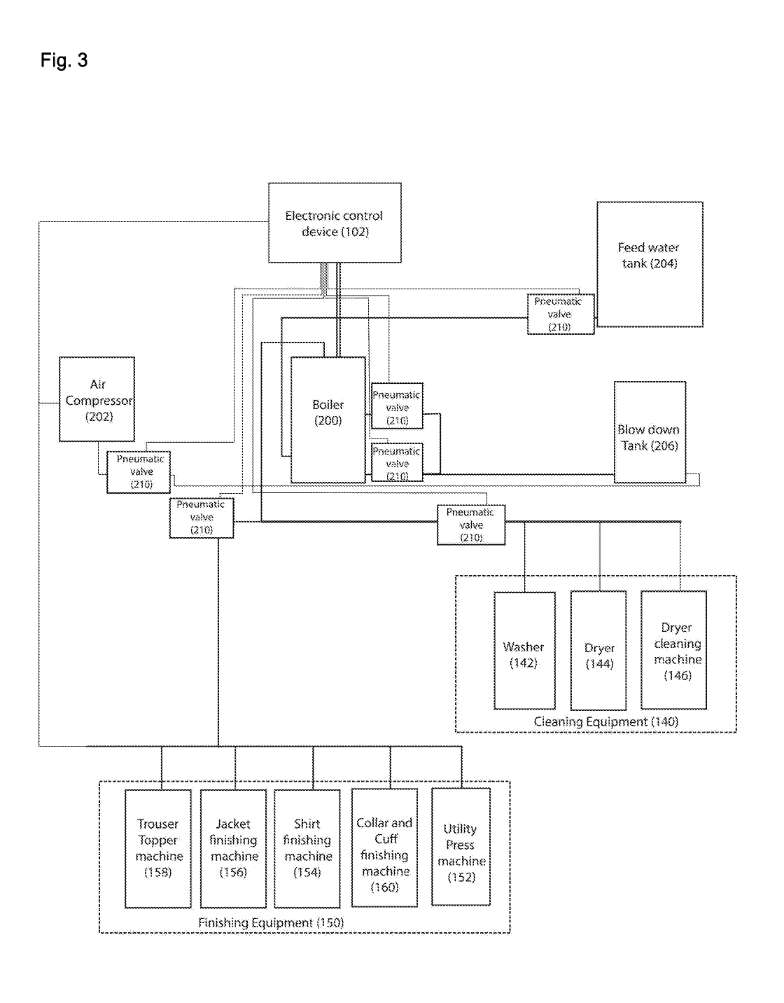

FIG. 2 illustrates a schematic diagram and FIG. 3 illustrates the corresponding line diagram showing the electronic control device 102 of the present automated system 100 employed to automate and efficient control of the equipment such as boiler vessels 200, air compressors 202, feed water tanks 204 and blowdown tanks 206 provided inside an industrial facility such as, but not limited to, dry cleaning, laundry, garment and textile industries, according to one or more embodiment of the present invention. In one or more embodiment, the present system 100 involving the electronic control device 102 can be used for controlling the equipment such as cleaning equipment 140 and finishing equipment 150 employing steam, water and compressed air in a facility such as, but not limited to, dry cleaning, laundry, garment and textile industries. The cleaning equipment 140 in such facilities include the washers 142, dryers 144 and the dryer cleaning machines 146 capable of operating utilizing the steam, compressed air, and water from the boiler 200, air compressor 202, the feed water tanks 204 and the blowdown tank 206. The finishing equipment 150 in such facilities include the utility press machines 152, shirt finishing machines 154, jacket finishing machines 156, trouser topping machines 158, collar and cuff finishing machines 160 etc. utilizing the steam and compressed air generated from the boiler 200 and the air compressor 202 to operate. The boiler 200 generates steam, based on the automation or scheduling program set on the electronic control device 102, and the live steam lines passes the steam to the cleaning equipment such as the washers, dryers and the dryer cleaning machines and to the finishing equipment. In some instances, the internal needle valve of the electronic control device 102 is utilized to directly control the speed of the main steam supply valve from the boiler 202, thereby scheduling or automating the efficient operation of the desired equipment in the facility such as the cleaning, washing and finishing equipment to optimize its operation. In some instances, the live steam lines pass through the air valves 114 controlled using the electronic control device 102, which in turn controls the steam supply to both the cleaning equipment 140 and finishing equipment 150 in the facility. Similarly, supply lines carrying the high pressure air generated using the air compressor 202, water from the water feed tank 204 are controlled by the electronic control device 102 using the air valves 114 based on preset or scheduling instructions given to the electronic control device 102 to control the air regular 106 and in turn the air valves 114, which in turn controls the pneumatic valves associated with each of the equipment in the facility. In some instances, the present system includes pneumatic valves associated with each of the steam, compressed air and water lines. The control of the air regulator 106 using the instructions of the programmable logic controller 110 provided with the electronic control device 102 controls the air valves 114 and the associated pneumatic valves 210 of the boiler 200, air compressors 202, the water feed tank 204 and the blow down tank 206 and helps in the efficient operation of each equipment. Further the pneumatic valves 210 associated with the sight glass 208 enables the purging of the sight glass 208 after a scheduled period of time or after a particular operation.

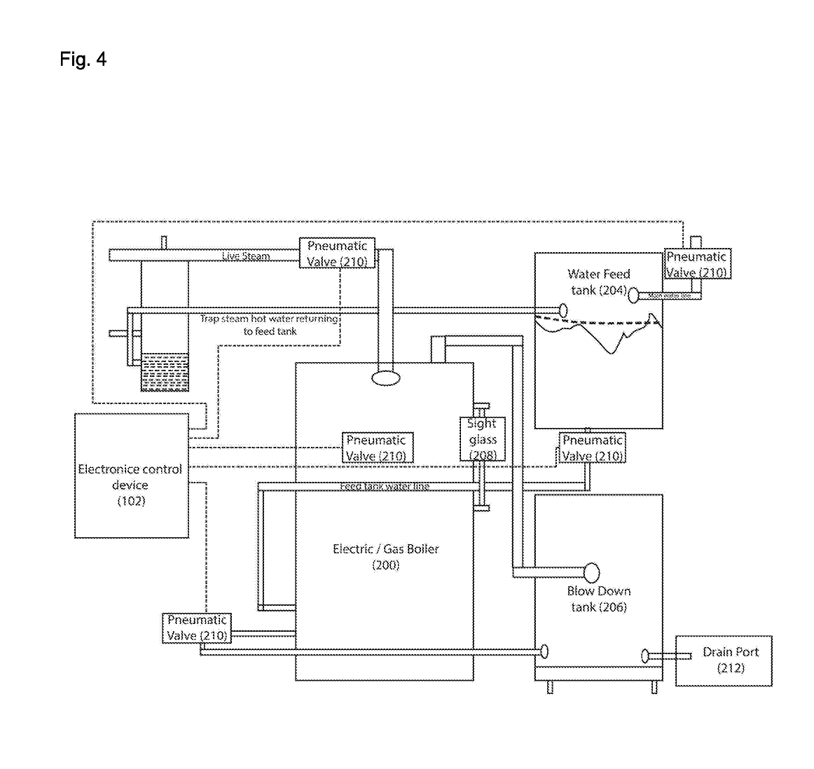

FIG. 4 is a line diagram showing the use of the electronic control device 102 to schedule and control the operations associated with the boiler 200 in the facility, according to an embodiment of the present invention. The live steam from the boiler 200 is controlled using the appropriate air valves 114 associated with the air regulator 106 or the needle valve of the present electronic control device 102. These air valves 114 controls the pneumatic valves 210 associated with the boiler, based on the pre-programmed instructions given through the human machine interface 112 associated with the programmable logic controller 110. This in turn automatically controls the steam supply from the boiler 200 to the different equipment including the cleaning equipment 140 such as the washer, dryer, dryer cleaning machine and the finishing equipment 150 such as the utility press machine, shirt finisher, jacket finisher, trouser topper machine, collar and cuff machine etc. Furthermore, the appropriate air valves 114 of the present electronic control device 102 can be configured or scheduled to automatically control the pneumatic valves 210 associated with the water supply from the feed water tank 204 to the boiler vessel 200 thereby controlling the steam generation. The air regulator 106 on the boiler vessel 200 controls the steam pressure supplied to the equipment. The sight glass 208 allows real time monitoring of the boiler 200. The cleaning of the boiler 200 can be scheduled using the present electronic control device 102 using the pneumatic valve 210 associated with the boiler 200 by configuring the air regulator 106 or the designated air valve 114 associated with the above pneumatic valve 210. This process, in some instance, also includes the purging of the sight glass 208 through the pneumatic valve 210 provided at the bottom of the sight glass 208 associated with the boiler 200. Thus the present automated system 100 and the associated electronic control device 102 can essentially be used to control and schedule the compressed air, water supply from feed lines, and the steam supply to the following equipment such as washing machines and wet washers, steam or electric dryers, dry cleaning machines of any solvents, automatic and manual finishing steam or electric presses, shirt, collar and cuff finishing machines, trousers, jackets finishing machines, etc., in a dry cleaning, laundry and garment and textile industry. In some instance, the electronic control device 102 is connected to one or more smart control valves or smart pneumatic valves 210, or smart solenoid valve 210, to automatically control the flow through the supply lines such as the steam supply from the boiler 200, water supply from the feed water tank 204 and the compressed air supply from the air compressor 202. A drain port 212 associated with the blow down tank 206, which temporarily collects the waste sediments inside the boilers 200 and other equipment in the facility and drains through the drain port 212 to the drainage system.

In some embodiment of the present automated system 100, the programmable logic controller 110 of the present electronic control device 102 is connected to a control circuit of the boiler vessels 200 or boiler system in the facility to control the ‘start’ and ‘stop’ operations of the boiler vessel 200. The operations of the equipment in the facility are continuously monitored by the programmable logic controller 110 through the monitoring means 108 installed at the predetermined locations within or at specific monitoring locations associated the equipment. For example, in the case of boiler vessels 200 in a facility, the monitoring means 108 includes ancillary contacts, which are connected to the internal contactors and a level switch within the boilers. In some other types of boilers 200, the monitoring means 108 includes ancillary contacts, which are connected to the internal contactors of the boiler 200 via a pressure transducer. The programmable logic controller 110 of the present electronic control device 102 receives the feedback from the different monitoring means 108 and dynamically processes the data based on the preset instructions to automatically control the operations of the cleaning 140 and finishing equipment 150 in the facility.

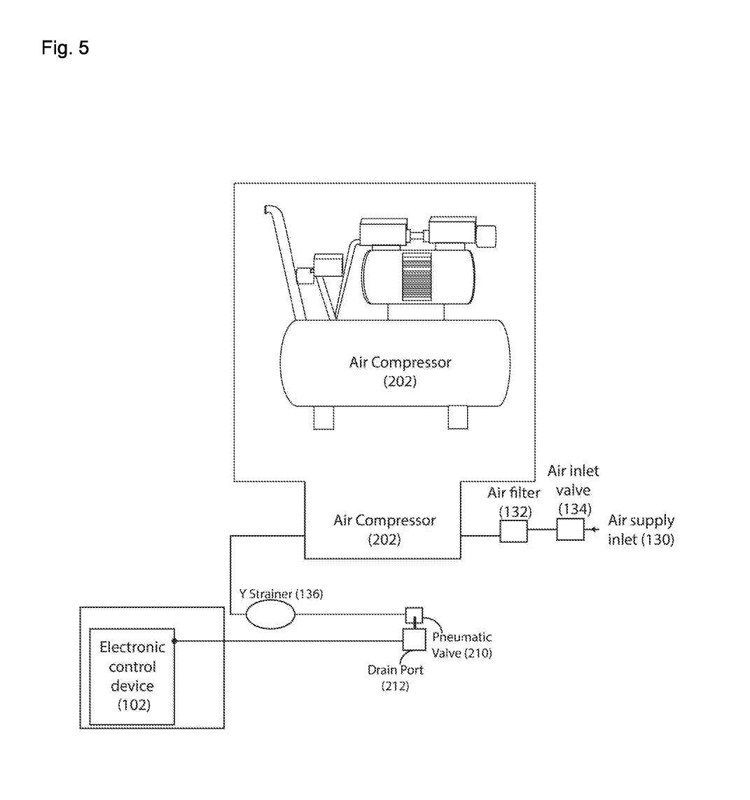

FIG. 5 illustrates a schematic diagram showing a connection of the electronic control device 102 to the air compressor 202 for performing scheduled, automated removal of the water build up in the air compressor 202 inside the facility, according to an embodiment of the present invention. The air compressor 202, receives the air through an air supply inlet 130 and passes through the air inlet valve 134 and the air filter 132 and the received air within the air compressor 202 is compressed to a desired pressure.

The electronic control device 102, in some instances, supplies the compressed air to multiple equipment in the facility by receiving the compressed air from the air compressor 202 through the air regulator 106 that connects to an internal air manifold to the air valves 114 of the electronic control device 102, which in turn controls the relevant pneumatic valves 210 supplying compressed air to the different equipment in the facility. In some instances, the compressed air is passed through a Y strainer 136 to remove particles that can damage the pneumatic valves 210. In a certain embodiment, the electronic control device 102 incorporates the air regulator 106 and the air valves 114 and the air supply lines connecting the compressed air supply line from the air compressor 202. The compressed air enters the electronic control device 102 through the air regulator 106 and the pneumatic valves 210 comprising a 6 mm bulkhead fitting provided at a base of the casing of the electronic control device 102. In some instances, the casing provides IP66 protection to the electronic control device 102 and the compressed air enters the electronic control device 102 through the air regulator 106 and the pneumatic valves 210 and then through the 6 mm bulkhead fitting, which runs along a perforated tray to the appropriate valve associated with the relevant equipment in the facility to supply the compressed air at desired pressure levels and for the desired duration. The cleaning or removal of the water build up in the compressor over continued operation is achieved by using the present electronic control device 102, which controls the air regulator 106 to open the pneumatic valve 210 to drain the water through the drain port 212.

Referring back to FIG. 1, the present electronic control device 102 further allows the authorized personnel to automate or schedule the starting and stopping operations of the boiler 200. The steam valves and the supply valve of the boiler 200 can be controlled by the electronic control device 102 based on pre-programmed instructions, sometimes given through the human machine interface 112. The steam valves are activated once the boiler 200 is heated to a set temperature and the pressure of the steam inside the boiler 200 slowly opens the valve by use of a pneumatic needle valve. The pneumatically controlled main steam valves thus slowly releases the steam to the relevant equipment in the facility. The present electronic control system 102 can be configured to close the main steam valve and the water supply valve once the boiler 200 operation is turned off, either automatically through scheduled instructions provided through the human machine interface 112 or manually or by notifying the authorized personnel. This processes prevents the flooding inside the boiler 200 due to the cooling down of the steam. Thus the present electronic control system 102 automates this process without the need of an operator.

The present electronic control device 102 further includes a data logging means to store a detailed operational track record of the scheduled and other automated tasks performed using the present device 102. In some instances, the device 102 compares the previous stored operational track record with the real-time or scheduled activities of the equipment and notifies the users through the interactive display on the human machine interface device 112 or through audible or other form of alerts. Further, the manual override switch allows the authorized users to turn the operations of the equipment in the facility into manual mode and verify the parameters using the data logging means associated with the present electronic control device 102 or through the human machine interface 112. The human machine interface 112 further allows the authorized users to visualize and change the scheduled settings of various equipment, time period of the scheduled operation of the various control valves and also the enables the full manual control of all the connected or operating equipment.

The present automated system 100 thus enables the users to set optimal operational parameters and scheduling of the equipment in the facility, increases the efficiency and reduces the workload of the human workforce, and increases the overall operating efficiency of the facility by reducing the standby time of different equipment. The electronic control device 102 of the present automated system 100 also enables the scheduling for the pre-start of the dry cleaning and the washing equipment prior to the arrival of the human workforce. The present automated system 100 further allows continuous, unmonitored operations of the different equipment in the facility, thereby improving the overall productivity and efficiency of the facility. The present automated system 100 and the associated electronic control device 102 can essentially be used to control and schedule the compressed air, water supply from feed lines, and the steam supply to the following equipment such as washing machines and wet washers, steam or electric dryers, dry cleaning machines of any solvents, automatic and manual finishing steam or electric presses, shirt, collar and cuff finishing machines, trousers, jackets finishing machines, etc., in a dry cleaning, laundry and garment and textile industry.

The automated system 100 and electronic control device 102 can be used as a system for preventative maintenance and for improving the energy efficiency by automatically starting, stopping and processing of electric steam and water based machinery. More particularly, the invention relates to the controlling of electric, pneumatic values for each part of the operation that use steam, water and air. The device will connect to any existing electrical systems that control the individual existing equipment being inlet/outlet valves, circuit breakers, pump timers, contactors and level switches for the machinery within the industries using steam, water and air, which includes dry cleaning, laundry and garment and textile industry. By automating the daily start-up in the above industry for boilers 200, washers, dryers, dry cleaning machines, air compressors 202 and finishing equipment, the electronic control device 102 with its inbuilt options, can schedule different starting times, manually override each piece of equipment, start and stop, drain, and allows the workflow and processing time of a plant to become efficient and easy to control and configure.

The foregoing description of the preferred and alternate embodiments of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

The claims defining the invention are as follows:

1. An automated system for managing a plurality of operations associated with at least one facility having a plurality of equipment operable using compressed air, water and steam supply comprising:
an electronic control device having a plurality of inputs and outputs configured to manage a plurality of automated, preset and real-time operations of the plurality of equipment in the facility;
a plurality of steam supply control means in communication with the electronic control device to control a steam supply from at least one steam supply mechanism to the plurality of equipment;
a compressed air supply control means in communication with the electronic control device to control a compressed air supply from at least one compressed air supply mechanisms to the plurality of equipment; and
a plurality of monitoring means installed at a plurality of locations associated with the compressed air supply mechanisms, the steam supply mechanisms and the plurality of equipment to provide a plurality of feedback information to the electronic control device,
whereby the electronic control device performs a plurality of automated, scheduled operations including start up, scheduled operation, automated cleaning and scheduled stopping of the plurality of equipment by controlling a plurality of electric and pneumatic values of the equipment based on analysis of a plurality of inputs provided to the electronic control device and a plurality of feedback information received from the plurality of monitoring means.

2. The automated system of claim 1 wherein the electronic control device includes:
a control panel;
a human machine interface for providing a plurality of real-time and a plurality of preprogrammed inputs; and
a programmable logic controller for controlling a plurality of operations of the plurality of equipment based on the plurality of real-time and preprogrammed inputs received through the human machine interface.

3. The automated system of claim 1 wherein the plurality of operations controlled using the electronic control device includes automated starting, stopping and cleaning of a plurality of boiler vessels, automated cleaning of a sight glass associated with the boiler vessel, starting and stopping of a plurality of steam circuits associated with the boiler vessel, starting, stopping and cleaning of a plurality of air compressors, and auto start and stopping of a plurality of washing, drying, and associated equipment in the facility, wherein the electronic control device performs the plurality of operations based on the plurality of real-time and a plurality of preprogrammed inputs received through the human machine interface.

4. The automated system of claim 2 wherein the human machine interface is housed in an IP66 rated enclosure enabling access by a plurality of authorized personnel through a touchscreen, a keyboard or an authorized external device.

5. The automated system of claim 2 wherein the electronic control device controls the operations of the boiler vessel through a boiler control circuit, wherein the electronic control device is connected with a plurality of control cables of the boiler control circuit in form of a plurality of inputs to the control panel enabling direct control of the boiler control circuit.

6. The automated system of claim 1 wherein the monitoring means includes a plurality of ancillary contacts configured to interact with a plurality of internal components of the boiler vessel to receive a plurality of real-time feedback information, wherein the electronic control device processes the real-time feedback information based on a plurality of preset instructions to dynamically adjust a plurality of real-time, automated and scheduled operations of the equipment including the boiler vessel.

7. The automated system of claim 1 wherein the electronic control device controls a plurality of pneumatic valves to control the compressed air supply from the air compressor, wherein the electronic control device includes at least one air regulator operated using the compressed air supply from the air compressor.

8. The automated system of claim 1 wherein the electronic control device includes a manual override switch to enable manual control of the plurality of operations of the equipment.

9. The automated system of claim 1 wherein the electronic control device includes a data logging means to store a plurality of information including a plurality of automated and scheduled operations of the equipment and a plurality manual operations performed by the authorized personnel.

10. The automated system of claim 1 wherein the electronic control device provides energy efficiency, improved performance and life span of the equipment, efficient labour management and automated operation of the facility.
